(19) United States
(12) Patent Application Publication
(10) Pub. No.: US 2008/0098247 A1
(43) Pub. Date: Apr. 24, 2008

(54) COMPUTER HAVING AUXILIARY DISPLAY APPARATUS

(75) Inventor: Won-joo LEE, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/762,351

(22) Filed: Jun. 13, 2007

(30) Foreign Application Priority Data
Oct. 18, 2006 (KR) 2006-101497

(51) Int. Cl. G06F 3/00; G06F 1/26

(52) U.S. Cl. 713/323; 710/1

(57) ABSTRACT

A computer includes a main body having a housing part, a main display unit connected to the main body which displays images, and an auxiliary display apparatus having an auxiliary display unit which displays additional images, wherein the auxiliary display apparatus is insertable into the housing part.

### CROSS-REFERENCE TO RELATED APPLICATION

This application claims the benefit of Korean Application No. 2006-101497, filed Oct. 18, 2006, in the Korean Intellectual Property Office, the disclosure of which is incorporated herein by reference.

### BACKGROUND OF THE INVENTION

1. Field of the Invention

Aspects of the present invention relate to a computer system, and more particularly to a computer system to which an auxiliary display apparatus is connected.

2. Description of the Related

Occasionally, a plurality of screens is used in one computer system so that a user can view images displayed through the different screens simultaneously. For a desktop computer, one of the images can be outputted through a monitor, and another of the images can outputted through an additional monitor. Similarly, for a portable computer such as a notebook computer, one of the images can be outputted through a main display apparatus, and another of the images can be outputted by connecting an additional display apparatus, such as a side show module, to the notebook computer.

FIG. 1A and FIG. 1B are block diagrams respectively illustrating a first and a second configuration of a conventional computer system which outputs different images through two screens. As shown in FIG. 1A, in the first configuration of a conventional computer system, the computer 2 transmits data to a main display apparatus (not shown) and an auxiliary display apparatus 1 through a universal serial bus (USB) protocol. Also, the conventional computer system transmits status data, such as a remaining amount of battery life, to the auxiliary display apparatus 1 through a system management bus (SMBUS). However, since the auxiliary display apparatus 1 is physically attached to the main display apparatus (not shown) of the computer 2, a thickness of the computer system is increased, and the computer system becomes more cumbersome to use and transport. Also, additional hardware such as a cable is required to attach and detach the auxiliary display apparatus 1 to the computer 2, increasing manufacturing costs for the conventional computer system.

As shown in FIG. 1B, in a second configuration of a conventional computer system, a computer 2 transmits and/or receives data to and/or from the auxiliary display apparatus 1 by a wireless protocol such as Bluetooth, so that the computer system can display one image through a main display apparatus and another image through the auxiliary display apparatus 1. However, this second configuration requires an additional power supply for a module used to transmit and/or receive data by the wireless protocol, which leads to a substantial increase in power consumption. Also, in the second configuration of a conventional computer system, there is a risk that various components of the computer system may get lost because the components are not physically connected to each other.

### SUMMARY OF THE INVENTION

Accordingly, it is an aspect of the present invention to provide a computer system including a computer and an auxiliary display apparatus which can be connected to the computer without requiring additional hardware or an additional communication module to display additional images, thus decreasing power consumption and increasing utility of the computer system.

Additional aspects of the present invention will be set forth in part in the description which follows and, in part, will be obvious from the description, or may be learned by practice of the present invention.

The foregoing and/or other aspects of the present invention can be achieved by providing a computer including a main body having a housing part, a main display unit connected to the main body which displays images, and an auxiliary display apparatus having an auxiliary display unit which displays additional images, wherein the auxiliary display apparatus is insertable into the housing part.

According to an aspect of the invention, the housing part includes a connection unit to connect the main body to the auxiliary display apparatus when the auxiliary display apparatus is inserted into the housing part.

According to an aspect of the invention, a guide part is disposed in the housing part to guide the auxiliary display apparatus when the auxiliary display apparatus is inserted into the housing part.

According to an aspect of the invention, the connection unit includes a PCI-Express slot.

According to an aspect of the invention, the housing part is disposed at one side of the main body, and includes a transparent member through which the auxiliary display unit displays the additional images when the auxiliary display apparatus is inserted into the housing part.

According to an aspect of the invention, the computer further includes a user input unit connected to the main body, and a control unit to control data transmission to and from the auxiliary display apparatus according to commands inputted into the user input unit.

According to an aspect of the invention, the computer further includes a communication unit to wirelessly transmit the data to and from the auxiliary display apparatus, wherein the control unit controls the communication unit.

According to an aspect of the invention, the communication unit includes a device complying with a Bluetooth specification.

According to an aspect of the invention, the computer further includes a power supply unit which supplies power to the auxiliary display apparatus when the auxiliary display apparatus is inserted into the housing part, wherein the control unit controls the power supply unit to supply an amount of power required to operate the auxiliary display apparatus in a standby mode when the computer is not being operated, and controls the power supply unit to supply an amount of power required to operate the auxiliary display apparatus in a normal mode when the computer is being operated.

The foregoing and/or other aspects of the present invention can be achieved by providing a computer according to another aspect of the present invention, including a main body, a main display unit connected to the main body which displays images, an auxiliary display unit which display additional images, and a housing part disposed in the main body and comprising a transparent member, wherein the auxiliary display unit is insertable into the housing part and displays the additional images through the transparent member when inserted into the housing part.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1A and FIG. 1B are block diagrams respectively illustrating a first and a second configuration of a conventional computer system;

FIG. 2A is a perspective view illustrating a computer system according to an embodiment of the present invention;

FIG. 2B is a plane view of the main body included in the computer system illustrated in FIG. 2A;

FIG. 3 is a block diagram illustrating a configuration of the computer included in the computer system illustrated in FIG. 2A; and

FIG. 4 is a block diagram illustrating a configuration of the auxiliary display apparatus included In the computer system illustrated in FIG. 2A.

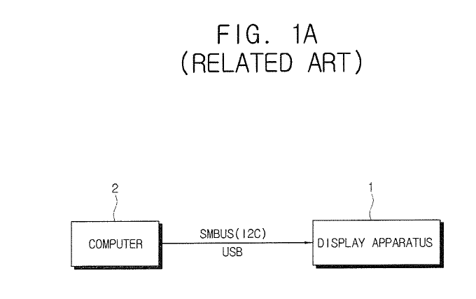

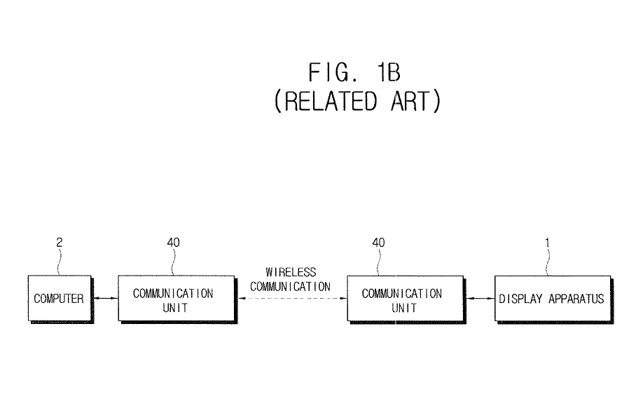

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

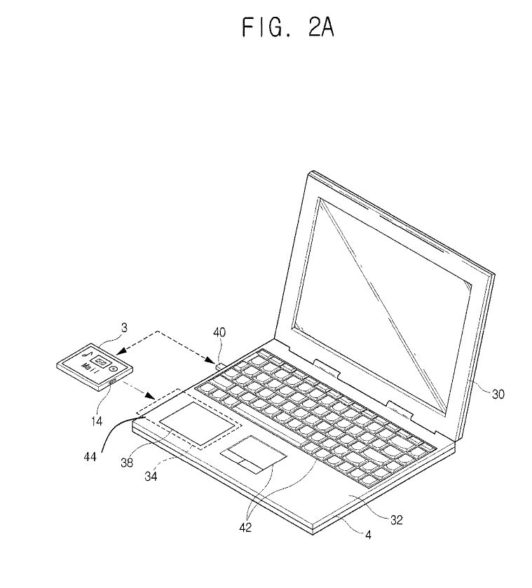

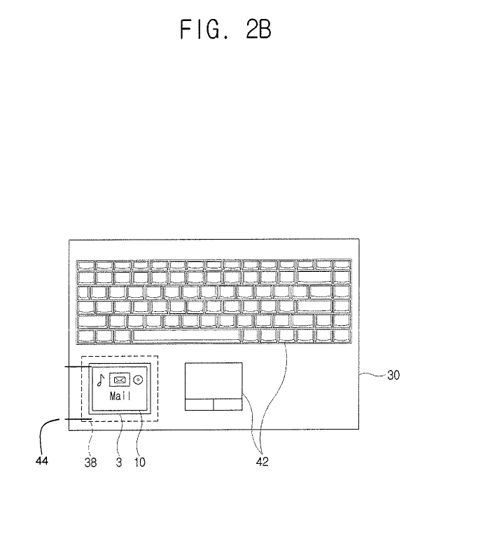

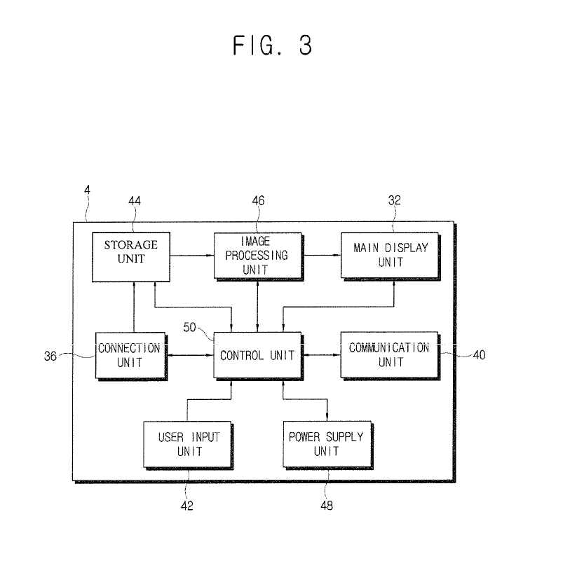

Hereinafter, a computer system according to an embodiment of the present invention is described in detail with reference to FIG. 2A, FIG. 2B and FIG. 3.

FIG. 2A is a perspective view of a computer system according to an embodiment of the present invention. As shown in FIG. 2A, the computer system according to an embodiment of the present invention includes a computer 4 having a main body 32, a main display unit 30, a housing part 34 (also known as a receptacle), a connection unit 36 (FIG. 3), a transparent member 38, a communication unit 40, and a user input unit 42. It is understood that the computer 4 is not limited to these components, and may have many other components in addition to those illustrated in FIG. 2A and described below, such as, for example, external speakers, joysticks, a mouse, an external disc drive, or any other component commonly used with computers.

The main body 32 of the computer 4 accommodates an auxiliary display apparatus 3 without requiring the use of an additional cable. The auxiliary display apparatus 3 is described in further detail below. The computer 4 is preferably, but not necessarily, a portable computer such as a notebook computer. However, the computer 4 is not limited to such, and may instead be another type of computer, such as a desktop computer. Additionally, the main body 32 includes a guide part 44 which guides the auxiliary display apparatus 3 into the housing part 34. The guide part 44 is preferably embodied as grooves within the housing part 34.

The main display unit 30 displays images based on a predetermined image signal. According to an aspect of the invention, the main display unit 30 is rotatably combined with the main body 32, and is preferably, but not necessarily, embodied as a liquid crystal display (LCD). However, the main display unit 30 is not required to be rotatably combined to the main body 32, and may instead be otherwise attached. For example, the main display unit 30 may be attached to the main body 32 by cords, such as in a desktop computer. Additionally, the main display unit 30 is not required to be an LCD screen, and may instead by another type of screen, such as a plasma display panel (PDP), etc.

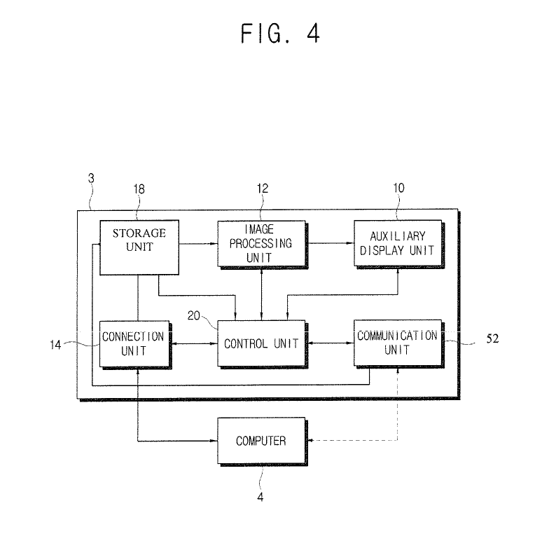

The housing part 34 accommodates the auxiliary display apparatus 3 so that an image displayed by the auxiliary display unit 10 (FIG. 4), which is included in the auxiliary display apparatus 3, can be displayed therethrough. The housing part 34 according to an aspect of the present invention includes the connection unit 36 (FIG. 3) and the transparent member 38, and is preferably, but not necessarily, a recess disposed at a side of the main body 32 as shown in FIG. 2A. Therefore, the auxiliary display apparatus 3 may be inserted into the housing part 34 and combined with the computer 4 without using any additional hardware, such as a cable. However, it is understood that the housing part 34 is not required to be a recess. Instead, the housing part 34 may be, for example, a frame disposed on top of the main body 32 which the auxiliary display apparatus 3 can snap into. The auxiliary display apparatus 3 can be directly attached to the main body 32 in many different places, such as on a side of the main body 32, on top of the main display unit 30, etc.

The connection unit 36 is disposed in the housing part 34 of the main body 32 and connects to the auxiliary display apparatus 3. The connection unit 36 preferably, but not necessarily, comprises a PCI-Express slot. It is understood, however, that the connection unit 36 is not limited to such, and may instead be another type, such as a PCI, PCI-X, or AGP slot. According to an aspect of the invention, the connection unit 36 is disposed at one outer side of the main body 32. Alternatively, the connection unit 36 may be disposed inside of the main body 32, as described later, so that the auxiliary display apparatus 3 can be completely inserted in the main body 32.

The transparent member 38 is disposed on the main body 32 so that the auxiliary display unit 10 of the auxiliary display apparatus 3 can display images therethrough. The transparent member 38 is preferably, but not necessarily, made of a transparent polycarbonate-acrylonitrile butadiene styrene (PC-ABS) material. However, the transparent member 38 is not limited to being a PC-ABS material, and may alternatively be many other types of transparent materials, such as glass or other types of plastics besides PC-ABS. As shown in FIG. 2B, if the connection unit 36 is disposed in the main body 32, the auxiliary display apparatus 3 can be inserted in the main body 32 and connected to the main body 32 by the connection unit 36, and the auxiliary display unit 10 included in the auxiliary display apparatus 3 can display images through the transparent member 38.

The communication unit 40 transmits and/or receives data to and/or from the auxiliary display apparatus 3. Preferably, but not necessarily, the transmission and reception of data between the communication unit 40 in the main body 32 and the communication unit 40 in the auxiliary display apparatus 3 is wireless. A control unit 50, which is described later in greater detail, controls the transmission and reception of data between the communication unit 40 and the auxiliary display apparatus 3. The communication unit 40 preferably, but not necessarily, complies with a Bluetooth specification which enables high speed data transmission and reception within a short range. However, it is understood that the communication unit 40 is not limited to complying with the Bluetooth specification, and may instead use other technologies, such as, for example, Wi-Fi technology.

The user input unit 42 receives commands inputted by a user, such as commands to transmit and/or receive data to and/or from the auxiliary display apparatus 3. If a user inputs a command to transmit data, the data which the user has requested to transmit is transmitted to the auxiliary display apparatus 3 through the connection unit 36. Also, if a user inputs a command to receive data, the data is received and saved in a storage unit 18 of the auxiliary display apparatus 3. Furthermore, data transmission and reception may be performed through the communication unit 40 as well as the connection unit 36.

Hereinafter, a configuration of the main body 32 of the computer 4 according to an aspect of the present invention is described in detail referring to FIG. 3. Descriptions of elements which are already described above are omitted.

A storage unit 44 saves data, and is preferably, but not necessarily, embodied as a hard disk, such as a ROM. However, it is understood that the storage unit 44 may be many other types of storage devices known in the art.

An image processing unit 46 performs image processing to display images on the main display unit 30. According to an aspect of the invention, the image processing unit 46 performs decoding to extract image information from inputted image signals, scaling to adjust resolution of the decoded image signals according to characteristics of the main display unit 302 and setting preferences of a user, and picture enhancement to enhance the quality of the images.

A power supply unit 48 supplies power required to operate the computer 4, and also supplies power required to operate the auxiliary display apparatus 3 if the auxiliary display apparatus 3 is connected to the main body 32. The power supply unit 48 may be various different types of power supplies commonly used with computers, such as a lithium ion battery.

If a user inputs a command into the user input unit 42 to transmit and/or receive data to and/or from the auxiliary display apparatus 3, the control unit 50 enables data transmission and/or reception to and/or from the auxiliary display apparatus 3 through the connection unit 36. In this case, the data transmitted to the auxiliary display apparatus 3 by the control unit 50 preferably, but not necessarily, includes status data which indicates a state of the main body 32, such as, for example, a remaining charge amount of a battery used as the power supply unit 48. Also, the auxiliary display apparatus 3 includes a control unit 20, which is preferably, but not necessarily, embodied as a microcomputer having software stored therein.

If a user enters a command to switch the main body 32 into a standby mode, the control unit 50 determines if the auxiliary display apparatus 3 is connected to the connection unit 36. Then, if the control unit 50 determines that the auxiliary display apparatus 3 is connected to the connection unit 36, the control unit 50 controls the power supply unit 48 to supply the auxiliary display apparatus 3 with the minimum amount of power required to operate in standby mode, so that power consumption can be minimized. Otherwise, when the main body 32 is operating in a normal mode, the control unit 50 controls the power supply unit 48 to supply the auxiliary display apparatus 3 with an amount of power required to operate in a normal mode. It is understood that a user may adjust the amount of power supplied to the auxiliary display apparatus 3 in various ways.

Hereinafter, the auxiliary display apparatus 3 according to an aspect of the present invention is described in detail referring to FIG. 4.

As shown in FIG. 4, the auxiliary display apparatus 3 includes the auxiliary display unit 10, an image processing unit 12, a connection unit 14, the storage unit 18, the control unit 20, and the communication unit 52.

The auxiliary display unit 10 and the main display unit 30 both display images, and are preferably, but not necessarily, embodied as LCD screens.

The image processing unit 12 performs image processing to display images on the auxiliary display unit 10. The image processing unit 12 preferably, but not necessarily, has the same configuration as the image processing unit 46 disposed in the main body 32 of the computer system. Alternatively, the image processing unit 12 may only have functions appropriate for simple image processing, such as playing a motion picture file, a music file, and other types of multimedia files, or displaying the contents of a document, such as a text file.

The connection unit 14 connects with the connection unit 36 disposed in the housing unit 34 of the main body 32, and is preferably, but not necessarily, embodied as a PCI-Express slot, as is the connection unit 36 of the main body 32.

The storage unit 16 saves data which is transmitted from the main body 32 through the connection unit 14 or the communication unit 52. Since the storage unit 16 is disposed in the auxiliary display apparatus 3, the storage unit 16 is preferably, but not necessarily, embodied as a flash memory, which is a non-volatile memory capable of miniaturization. It is understood that the storage unit 16 is not limited to being a flash memory, and may be various other types of volatile and non-volatile memories.

When data is transmitted from the main body 32 through the connection unit 14 or the communication unit 52, the control unit 18 preferably controls the image processing unit 12 to display the transmitted data on the auxiliary display unit 10. Alternatively, the control unit 18 can save the transmitted data in the storage unit 16. Furthermore, the auxiliary display apparatus 3 may include a user input unit (not shown) which a user can input commands into. For example, a user can input a command into the user input unit (not shown) to transmit the data saved in the storage unit 16 to the main body 32 through the connection unit 14 and the communication unit 52.

If a user inputs a display command into the user input unit (not shown) disposed on the auxiliary display apparatus 3, the control unit 18 controls the image processing unit 12 to display the data saved in the storage unit 16. Therefore, the auxiliary display apparatus 3 can be easily combined with the main body 32 of the computer system, and display images independently.

The control unit 18 controls the connection unit 14 and the communication unit 52 to transmit and/or receive data to and/or from the auxiliary display apparatus 3. The communication unit 52 in the auxiliary display apparatus 3 is preferably the same type of unit as the communication unit 40 disposed in the computer 4 and preferably transmits and/or receives data according to the Bluetooth specification. It is understood that the communication unit 52 in the auxiliary display apparatus 3 is not required to be identical to the communication 40 disposed in the computer 4, as long as the two communication units 52 and 40 can communicate with each other.

As described above, in the computer system according to aspects of the present invention, an auxiliary display apparatus 3 can be easily connected to the computer 4 without using additional hardware, such as a cable, and without increasing power consumption. Also, the computer system according to aspects of the present invention may include more than one auxiliary display apparatus 3, in case a user desires to view more than two screens.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A computer comprising:
a main body having a housing part;
a main display unit connected to the main body which displays images; and
an auxiliary display apparatus having an auxiliary display unit which displays additional images, wherein the auxiliary display apparatus is insertable into the housing part.

2. The computer according to claim 1, wherein the housing part comprises a connection unit to connect the main body to the auxiliary display apparatus when the auxiliary display apparatus is inserted into the housing part.

3. The computer according to claim 1, wherein a guide part is disposed in the housing part to guide the auxiliary display apparatus when the auxiliary display apparatus is inserted into the housing part.

4. The computer according to claim 2, wherein the connection unit comprises a PCI-Express slot.

5. The computer according to claim 1, wherein the housing part is disposed at one side of the main body, and comprises a transparent member through which the auxiliary display unit displays the additional images when the auxiliary display apparatus is inserted into the housing part.

6. The computer according to claim 1, further comprising:
a user input unit connected to the main body; and
a control unit to control a transmission of data to and from the auxiliary display apparatus according to commands inputted into the user input unit.

7. The computer according to claim 6, further comprising a communication unit to wirelessly transmit the data to and from the auxiliary display apparatus,
wherein the control unit controls the communication unit.

8. The computer according to claim 7, wherein the communication unit comprises a device complying with a Bluetooth specification.

9. The computer according to claim 1, further comprising a power supply unit which supplies power to the auxiliary display apparatus when the auxiliary display apparatus is inserted into the housing part,
wherein the control unit controls the power supply unit to supply an amount of power required to operate the auxiliary display apparatus in a standby mode when the computer is not being operated, and controls the power supply unit to supply an amount of power required to operate the auxiliary display apparatus in a normal mode when the computer is being operated.

10. The computer according to claim 5, wherein the transparent member comprises a polycarbonate-acrylonitrile butadiene styrene (PC-ABS) material.

11. A computer, comprising:
a main body;
a main display unit connected to the main body which displays images;
an auxiliary display unit which displays additional images; and
a housing part disposed in the main body and comprising a transparent member, wherein the auxiliary display unit is insertable into the housing part and displays the additional images through the transparent member when inserted into the housing part.

12. The computer according to claim 11, wherein the auxiliary display unit does not display the additional images when not inserted into the housing part.

13. The computer according to claim 11, wherein the housing part comprises a connection unit to connect the main body to the auxiliary display unit when the auxiliary display unit is inserted into the housing part.

14. The computer according to claim 13, wherein the connection unit comprises a PCI-Express slot.

15. The computer according to claim 11, further comprising:
a user input unit connected to the main body; and
a control unit to control a transmission of data to and from the auxiliary display unit according to commands inputted into the user input unit.

16. The computer according to claim 15, further comprising a communication unit to wirelessly transmit the data to and from the auxiliary display unit.

17. The computer according to claim 16, wherein the communication unit comprises a device complying with a Bluetooth specification.

18. A computer to communicate with an auxiliary display unit, comprising:
a main body;
a main display unit connected to the main body which displays images; and
a receptacle disposed in the main body and having a transparent member, wherein the receptacle is configured such that the auxiliary display unit displays additional images through the transparent member when the auxiliary display unit is inserted into the receptacle.

19. The computer according to claim 18, wherein the auxiliary display unit does not display the additional images when not inserted into the receptacle.

20. The computer according to claim 18, wherein the receptacle comprises a connection unit to connect the main body to the auxiliary display unit when the auxiliary display unit is inserted into the receptacle.

21. An auxiliary display apparatus which connects to a computer, comprising:
an auxiliary display unit to display images; and
a connection unit to enable communication between the auxiliary display apparatus and the computer when the connection unit contacts the computer.

22. The auxiliary display apparatus according to claim 21, wherein the auxiliary display apparatus contacts the computer by being inserted inside of the computer so that the connection unit connects with the computer.

23. The auxiliary display apparatus according to claim 22, wherein the auxiliary display apparatus displays images when contacting the computer, and otherwise does not display the images.

24. The auxiliary display apparatus according to claim 21, wherein the auxiliary display unit comprises an LCD screen.
